(19) United States
(12) Patent Application Publication
(10) Pub. No.: US 2025/0208336 A1
(43) Pub. Date: Jun. 26, 2025

(54) PANEL LIGHT GUIDE MODULE OF SOLID-STATE DRIVE

(71) Applicant: AIC INC., Taoyuan City (TW)

(72) Inventors: Chien-Hsing HSU, Taoyuan City (TW); Lung-Chuan LIAO, Taoyuan City (TW)

(21) Appl. No.: 18/391,600

(22) Filed: Dec. 20, 2023

(51) Int. Cl. F21V 8/00; G06F 3/06

(52) U.S. Cl. CPC G02B 6/0095; G02B 6/0023; G02B 6/0088; G06F 3/0679

(57) ABSTRACT

A panel light guide module for a solid-state drive includes a panel shell and a light guide structure. The panel shell includes a housing and a panel combined to the housing. The panel includes a light source hole. The light guide structure includes a light guide cover combined with the housing and a light guide column positioned on the light guide cover. The light guide column includes a light-receiving surface facing the light sources and a light-emitting surface facing the light source hole. The light sources positioned on different installation surfaces include a plurality of luminous surfaces, and the light-receiving surface faces the luminous surfaces of the light sources and receive the light emitted from the light sources.

### BACKGROUND OF THE DISCLOSURE

### Technical Field

The technical field relates to a solid-state drive, and more particularly relates to a panel light guide module for a solid-state drive.

### Description of Related Art

A solid-state drive (SSD) is a data storage device that has faster reading speed, shorter latency, higher durability, and reliability than hard drives of the related art. Additionally, solid-state drives are becoming increasingly common and have been widely used in computers or data centers.

Moreover, the panel indicator light of the solid-state drive (SSD) panel is an identification component that helps users understand the status and operation of the device. Users may easily understand the working status of the device through the panel indicator light. Furthermore, some SSDs may need the panel indicator light during operation or maintenance. Therefore, the position of the panel indicator light of SSD is crucial to user experience and device functionality.

Moreover, there are many brands of SSDs on the market. However, most of the positions of the panel light indicators of various SSDs are different. In this regard, manufacturers of SSDs need to produce different panel modules for each brand of SSDs, and that results in inconvenience in the manufacturing process. As a result, how to provide panel light indicators that may be applied to multiple brands of SSDs is the research motivation of this disclosure.

### SUMMARY OF THE DISCLOSURE

One object of this disclosure is to provide a panel light guide module for a solid-state drive to guide the light emitted from the light sources positioned on different installation surfaces, and to offer a common panel light guide module for solid-state drives.

This disclosure is a panel light guide module for a solid-state drive to guide the light emitted from the light sources positioned on different installation surfaces. The panel shell includes a housing and a panel combined to the housing. The panel includes at least one light source hole. A light guide structure includes a light guide cover combined with the housing and at least one light guide column positioned on the light guide cover. The at least one light guide column includes a light-receiving surface facing the light sources and a light-emitting surfaces facing the at least one light source hole. The light sources positioned on different installation surfaces include a plurality of luminous surfaces. The light-receiving surface faces the luminous surface of the light sources and receives the light emitted from the light sources.

In one embodiment of this disclosure, the light guide cover includes a plurality of positioning structures, and the light guide column is fixed on the plurality of positioning structures.

In one embodiment of this disclosure, a plurality of positioning holes is defined on the plurality of positioning structures, the light guide column includes a plurality of positioning posts, and the plurality of positioning posts are inserted in the plurality of positioning holes.

In one embodiment of this disclosure, the plurality of positioning structures includes a plurality of positioning ribs surrounding both sides of the plurality of positioning holes, and the light guide column is inserted between the plurality of positioning ribs.

In one embodiment of this disclosure, the light guide structure further includes light-transmitting piece, one side of the light-transmitting piece is exposed from the light source hole, and another side of the light-transmitting piece is adjacent to the light-emitting surface of the light guide column.

In one embodiment of this disclosure, the light source hole, the light guide column and the light-transmitting piece is multiple in number.

In one embodiment of this disclosure, the light guide column includes a pillar and a block connected to the pillar, the pillar includes the light-emitting surface, and the block includes the light-receiving surface.

In one embodiment of this disclosure, the light guide column includes a neck section connected to the pillar and the block, and a curved surface is defined on an outer periphery of the neck section.

In one embodiment of this disclosure, the panel light guide module further includes a first spring, one end of the first spring is abutted against the panel, another end of the first spring is abutted against the housing, and the panel returns to an original position through an elastic restoring force of the first spring.

In one embodiment of this disclosure, the panel shell further includes a plate key and a second spring, one end of the second spring is abutted against the plate key, another end of the second spring is abutted against the housing, and the plate key returns to an original position through an elastic restoring force of the second spring.

In one embodiment of this disclosure, the panel includes a hook located on a side thereof facing the plate key, and the plate key is pressed against the hook.

In one embodiment of this disclosure, the first spring is a torsion spring, and the second spring is a compression spring.

In comparison with the related art, the panel light guide module for a solid-state drive of this disclosure may guide the light emitted from the light sources positioned on different installation surfaces. The light guide column of the light guide structure has a light-receiving surface facing the light source and a light-emitting surface facing the light source hole. Furthermore, the light sources positioned on different installation surfaces includes multiple luminous surfaces. The light-receiving surface of the light guide column faces the luminous surfaces of the light sources, receives and reflects the emitted light, and then the light passes through the light source hole to display the light signal. The practicality of the disclosure is increased.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective schematic view of the solid-state drive in this disclosure.

FIG. 2 is a partially enlarged view of the solid-state drive in this disclosure.

FIG. 3 is a combination schematic view of the panel light guide module and the solid-state drive in this disclosure.

FIG. 4 is a perspective exploded view of the panel light guide module in this disclosure.

FIG. 5 is a perspective schematic view of the light guide column in this disclosure.

FIG. 6 and FIG. 7 are partially cross-sectional views illustrating the combination of the panel light guide module and the solid-state drive in this disclosure.

FIG. 8 is a schematic view illustrating the path of the light source entering the panel light guide module in this disclosure.

FIG. 9 is a perspective schematic view depicting the combination of the panel light guide module with another solid-state drive in this disclosure.

FIG. 10 is a partially cross-sectional view illustrating the combination of the panel light guide module with another solid-state drive in this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

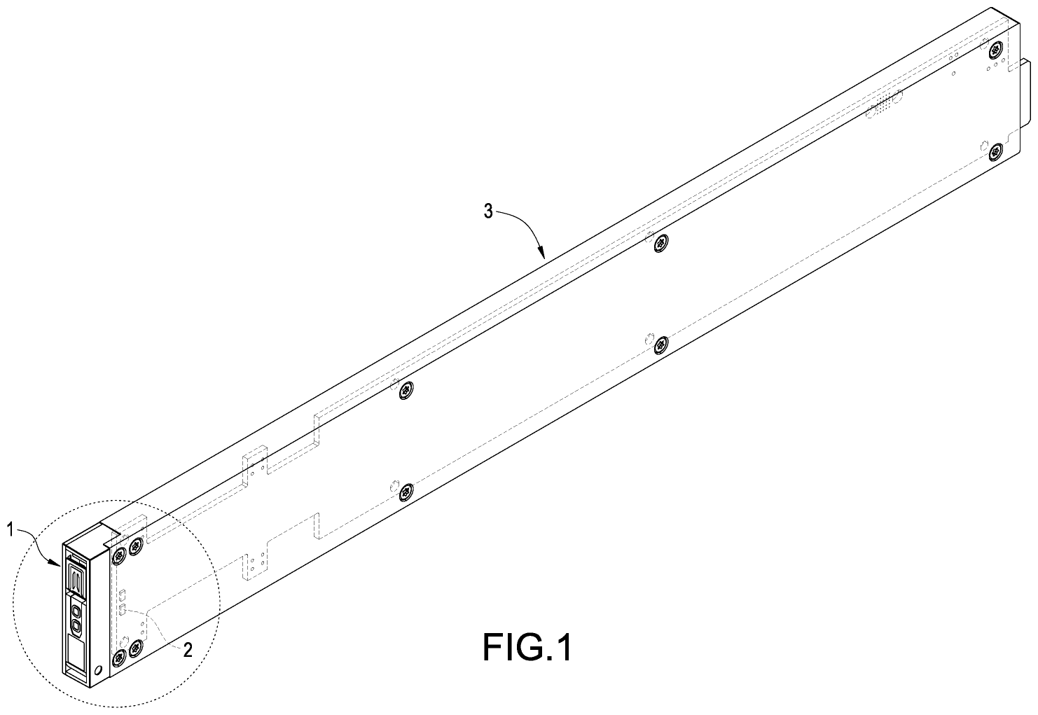

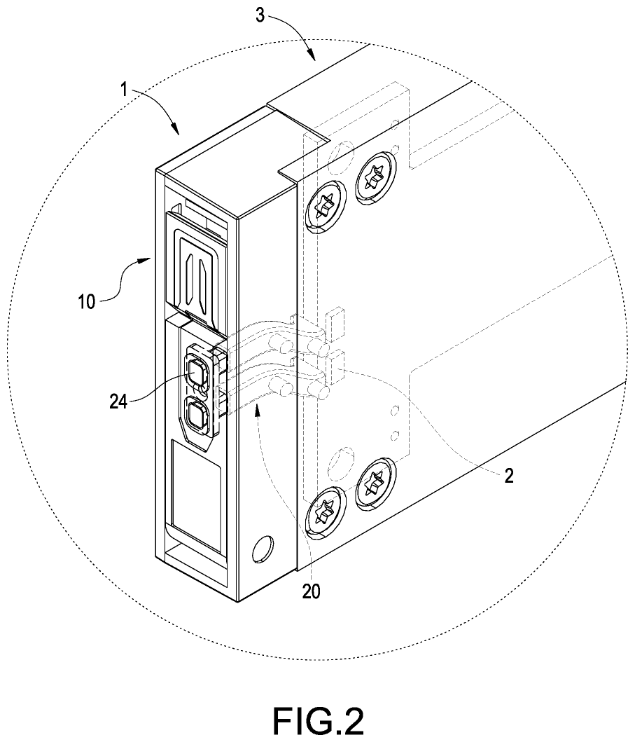

Please refer to FIG. 1 and FIG. 2, which are a perspective schematic view of the solid-state drive in this disclosure, and a partially enlarged view of the solid-state drive in this disclosure. This disclosure is a panel light guide module 1 for a solid-state drive 3 to assist users in identifying the status of the solid-state drive 3. A light source 2 is positioned on the solid-state drive 3, and the panel light guide module 1 is combined to one side of the solid-state drive 3.

The panel light guide module 1 includes a panel shell 10 and a light guide structure 20. The light guide structure 20 is combined in the panel shell 10 to guide the light from the light source 2 positioned on the solid-state drive 3. Consequently, the light emitted from the light source 2 may pass through the light-transmitting piece 24 to be displayed on the panel shell 10. A more detailed description of the panel light guide module 1 is provided as follows.

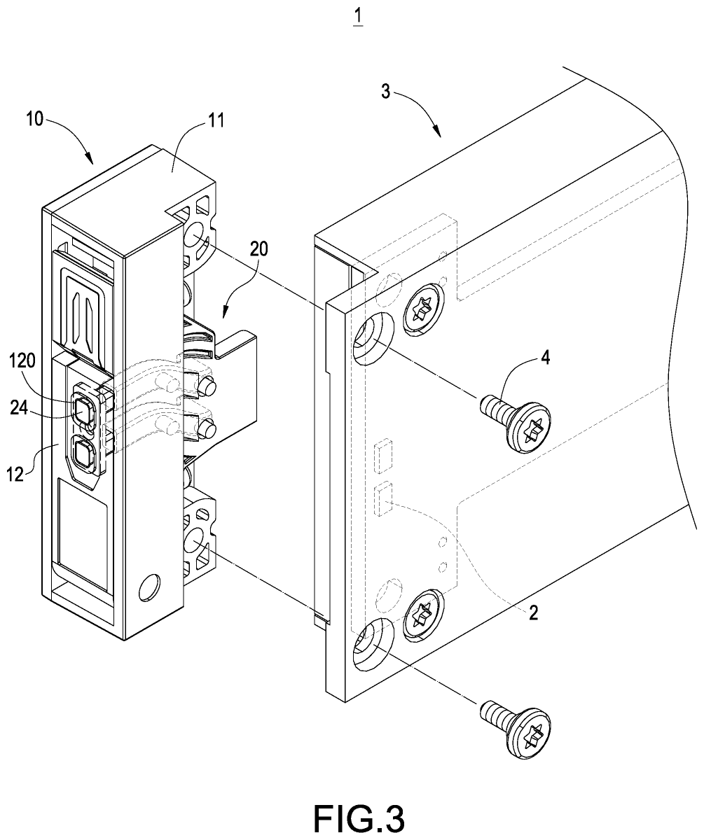

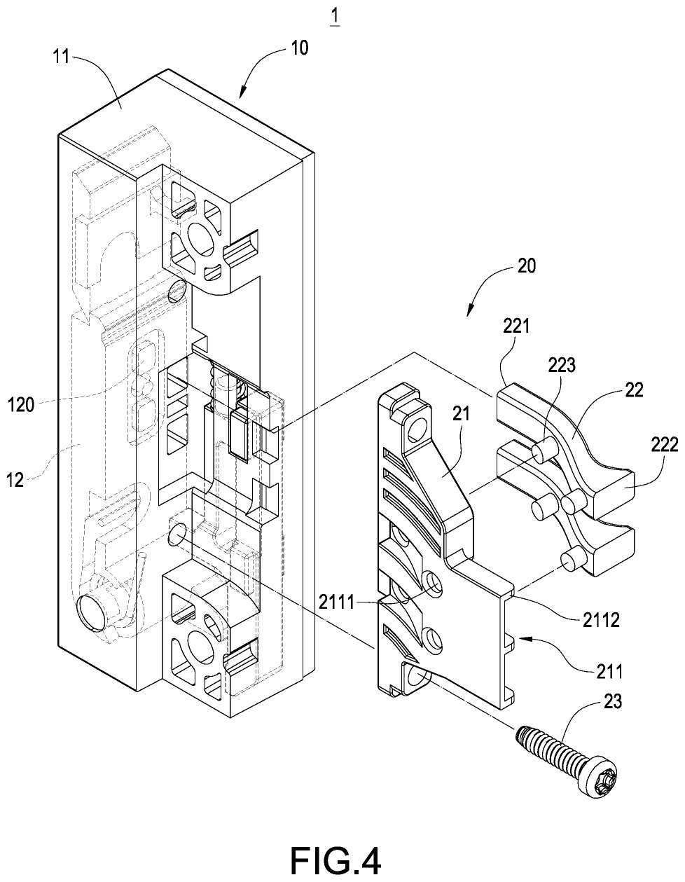

Please further refer to FIG. 3 and FIG. 4, which are a combination schematic view of the panel light guide module and the solid-state drive in this disclosure and a perspective exploded view of the panel light guide module in this disclosure. The panel shell 10 includes a housing 11 and a panel 12 combined to the housing 11, and the panel 12 includes at least one light source hole 120. In this embodiment, the panel shell 10 is fastened on one side of the solid-state drive 3 through a plurality of screws 4. The light emitted from the light source 2 passes through the light source hole 120 via the guiding of the light guide structure 20.

Moreover, the light guide structure 20 includes a light guide cover 21 combined with the housing 11 and at least one light guide column 22 positioned on the light guide cover 21. The light guide column 22 includes a light-receiving surface 222 facing the light sources 2 and a light-emitting surface 221 facing the light source hole 120.

Specifically, the light guide cover 21 includes a plurality of positioning structures 211. The light guide column 22 is secured on the positioning structures 211. In more detailed, a plurality of positioning holes 2111 are defined on the positioning structures 211. Furthermore, the light guide column 22 includes a plurality of positioning posts 223. Accordingly, the light guide column 22 is positioned on the light guide cover 21 through the insertion of the positioning posts 223 into the positioning holes 2111. In this embodiment, the light guide cover 21 is combined in the housing 11 through a plurality of locking elements 23 to position the light guide column 22.

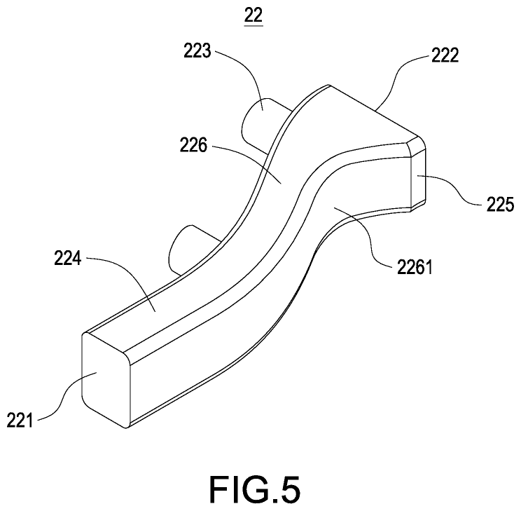

Please further refer to FIG. 5, which is a perspective schematic view of the light guide column in this disclosure. In this embodiment, the light guide column 22 includes a pillar 224 and a block 225 connected to the pillar 224. The pillar 224 includes the light-emitting surface 221, and the block 225 includes the light-receiving surface 222. Additionally, the light guide column 22 includes a neck section 226 connected between the pillar 224 and the block 225, and a curved surface 2261 is defined on an outer periphery of the neck section 226.

In this embodiment, the size of the light-receiving surface 222 is approximately 2.5 mm in width and 3.5 mm in length, but this is not limited. The dimensions of the light-receiving surface 222 are primarily designed to cover the positions of multiple light source positions, enabling the combination with various models or brands of panels on different solid-state drives.

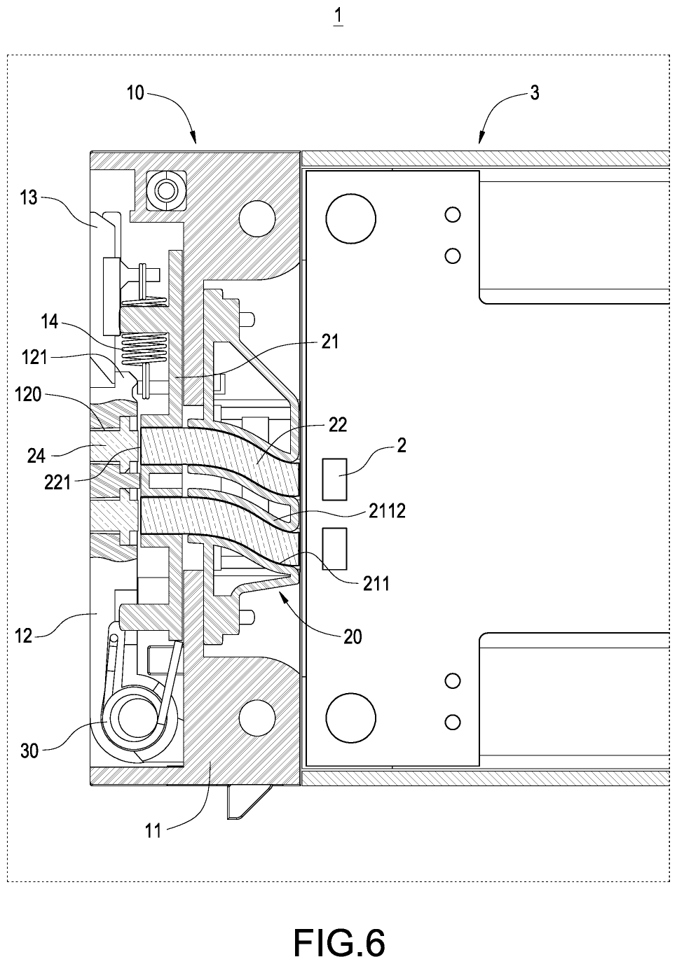

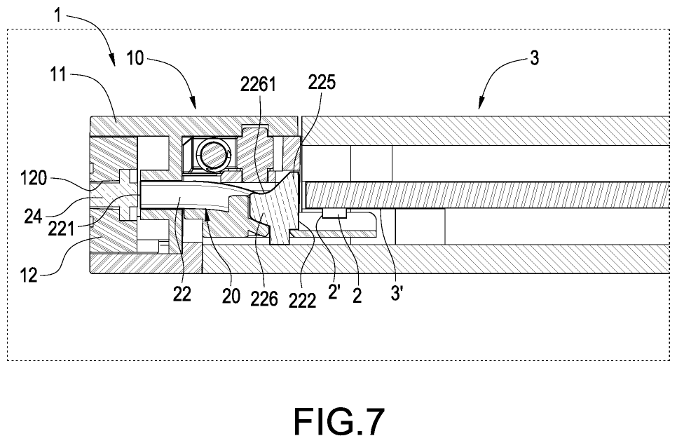

Please further refer to FIG. 6 and FIG. 7, which are partially cross-sectional views illustrating the combination of the panel light guide module and the solid-state drive in this disclosure. As shown in FIG. 6, the panel light guide module 1 further includes a first spring 30. One end of the first spring 30 abuts against the panel 12, and another end of the first spring 30 abuts against the housing 11. As a result, the panel 12 returns to the original position through the elastic restoring force of the first spring 30. In this embodiment, the first spring 30 is a torsion spring.

Furthermore, the panel shell 10 further includes a plate key 13 and a second spring 14. One end of the second spring 14 abuts against the plate key 13, and another end of the second spring 14 abuts against the housing 11. As a result, the plate key 13 returns to the original position through the elastic restoring force of the second spring 14. In this embodiment, the second spring 14 is a compression spring. Additionally, the panel 12 includes a hook 121 located on a side thereof facing the plate key 13, and the plate key 13 presses against the hook 121.

Therefore, users may press the plate key 13 to disengage the panel 12, facilitating the application of force to rotate and open the panel 12.

Moreover, the light guide structure 20 further includes at least one light-transmitting piece 24. The light-transmitting piece 24 is inserted in the light source hole 120. One side of the light-transmitting piece 24 is exposed from the light source hole 120, and another side of the light-transmitting piece 24 is located adjacent to the light-emitting surface 221 of the light guide column 22.

In this embodiment, there are multiple light source holes 120, multiple light guide columns 22, and multiple light-transmitting pieces 24 to enhance the indication effect.

It should be noted that the positioning structures 211 of the light guide cover 21 further includes a plurality of positioning ribs 2112 surrounding both sides of the positioning holes 2111 (refer to FIG. 4). The light guide column 22 is inserted between the positioning ribs 211 to be positioned on one side of the light guide cover 21 without shaking.

As shown in FIG. 7, the light source 2 of this disclosure includes a luminous surface 2′, and the light source 2 is arranged on an installation surface 3′ of the solid-state drive 3. In this embodiment, the installation surface 3′ is the lower plane of a circuit board. Moreover, the panel light guide module 1 is disposed on one side of the light source 2. The light-receiving surface 222 of the light guide column 22 faces the luminous surface 2′ of the light source 2 and receives the light emitted from the light source 2.

It is worth noticing that the light emitted from the light source 2 enters the block 225 from the light-receiving surface 222, and is concentrated and refracted through the curved surface 2261.

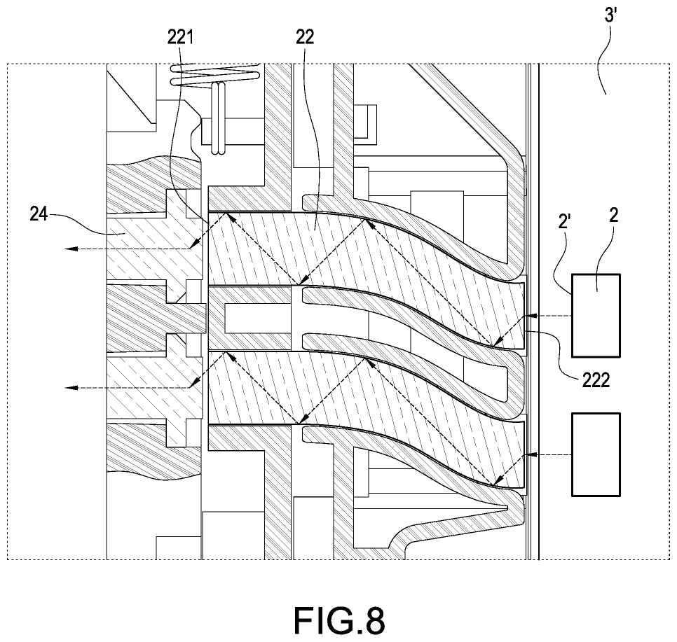

Please further refer to FIG. 8, which is a schematic view illustrating the path of the light source entering the panel light guide module in this disclosure. In this embodiment, the light source 2 is located on the installation surface 3′. The light is emitted from the luminous surface 2′ and enters the light guide column 22, and is reflected through the pillar 224 to emit from the light-emitting surface 221. It then exits the light-transmitting piece 24 to display a light signal.

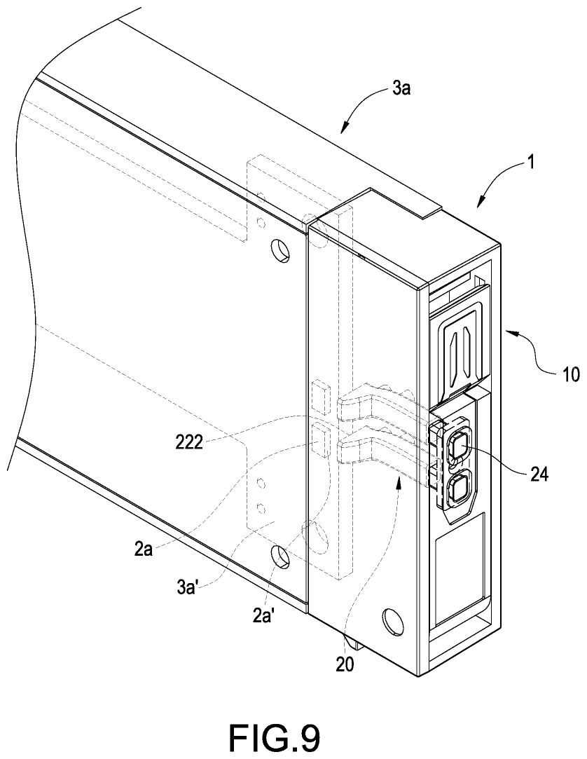

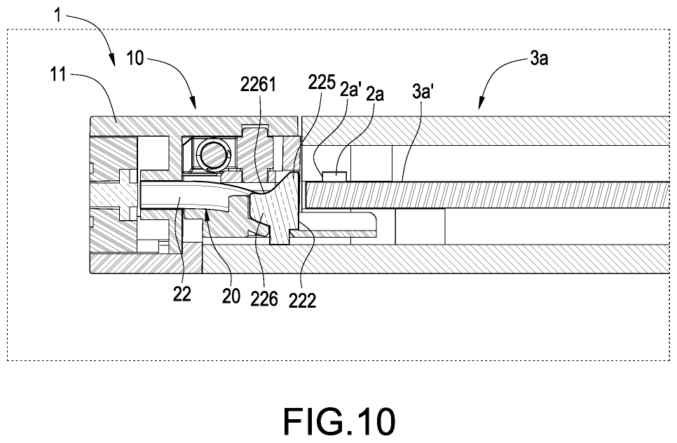

Please further refer to FIG. 9 and FIG. 10, which are a perspective schematic view depicting the combination of the panel light guide module with another solid-state drive in this disclosure and a partially cross-sectional view illustrating the combination of the panel light guide module with another solid-state drive in this disclosure. In this embodiment, the panel light guide module 1 is attached to another solid-state drive 3a. A light source 2a is positioned on the solid-state drive 3a, and the panel light guide module 1 is attached to one side of the light source 2a. Additionally, the structure of the panel light guide module 1 is similar to that of the previous embodiment. The panel light guide module 1 includes a panel shell 10 and a light guide structure 20. The light guide structure 20 includes a light guide column 22.

The difference between this embodiment and the previous embodiment is that the position of the light source 2a. In this embodiment, the light source 2a includes a luminous surface 2a′. The light source 2a is arranged on an installation surface 3a′ of the solid-state drive 3a, and the installation surface 3a′ is an upper plane of a circuit board. Additionally, the light-receiving surface 222 of the light guide column 22 faces the luminous surface 2a′ of the light source 2a to receive the light emitted from the light source 2a.

In summary, the panel light guide module 1 of this disclosure may guide the light sources 2, 2a positioned on different installation surfaces. The light sources 2, 2a situated on different installation surfaces 3′, 3a′ include a plurality of luminous surfaces 2′, 2a′. The light-receiving surface 222 faces the luminous surfaces 2′, 2a′ of the light sources 2, 2a, and receives the light emitted from the light sources 2, 2a.

While this disclosure has been described by means of specific embodiments, numerous modifications and variations could be made thereto by those skilled in the art without departing from the scope and spirit of this disclosure set forth in the claims.

What is claimed is:

1. A panel light guide module for a solid-state drive, guiding a light emitted from a plurality of light sources positioned on a plurality of installation surfaces, the panel light guide module comprising:
a panel shell, comprising a housing and a panel combined to the housing, the panel comprising at least one light source hole; and
a light guide structure, comprising a light guide cover combined with the housing and at least one light guide column positioned on the light guide cover, the light guide column comprising a light-receiving surface facing the light sources and a light-emitting surface facing the light source hole;
wherein, the light sources comprise a plurality of luminous surfaces, and the light-receiving surface faces the luminous surfaces of the light sources and receives the light emitted from the light sources.

2. The panel light guide module according to claim 1, wherein the light guide cover comprises a plurality of positioning structures, and the light guide column is fixed on the positioning structures.

3. The panel light guide module according to claim 2, wherein the positioning structures comprises a plurality of positioning holes defined thereon, the light guide column comprises a plurality of positioning posts, and the positioning posts are inserted in the positioning holes.

4. The panel light guide module according to claim 3, wherein the plurality of positioning structures comprises a plurality of positioning ribs surrounding two sides of each of the positioning holes, and the light guide column is inserted between two of the positioning ribs.

5. The panel light guide module according to claim 1, wherein the light guide structure further comprises at least one light-transmitting piece, one side of the light-transmitting piece is exposed from the light source hole, and another side of the light-transmitting piece is located adjacent to the light-emitting surface of the light guide column.

6. The panel light guide module according to claim 5, wherein an amount of the light source hole, an amount of the light guide column and an amount of the light-transmitting piece respectively are multiple.

7. The panel light guide module according to claim 1, wherein the light guide column comprises a pillar and a block connected to the pillar, the pillar comprises the light-emitting surface, and the block comprises the light-receiving surface.

8. The panel light guide module according to claim 7, wherein the light guide column comprises a neck section connected between the pillar and the block, and a curved surface is defined on an outer periphery of the neck section.

9. The panel light guide module according to claim 1, further comprising a first spring, wherein one end of the first spring abuts against the panel, another end of the first spring abuts against the housing, and the panel returns to an original position through an elastic restoring force of the first spring.

10. The panel light guide module according to claim 9, wherein the panel shell further comprises a plate key and a second spring, one end of the second spring abuts against the plate key, another end of the second spring abuts against the housing, and the plate key returns to an original position through an elastic restoring force of the second spring.

11. The panel light guide module according to claim 10, wherein the panel comprises a hook located on a side thereof facing the plate key, and the plate key presses against the hook.

12. The panel light guide module according to claim 11, wherein the first spring is a torsion spring, and the second spring is a compression spring.
